(19) United States
(12) Patent Application Publication
(10) Pub. No.: US 2014/0166376 A1
(43) Pub. Date: Jun. 19, 2014

(54) EQUALIZER BAR END JOINT

(71) Applicant: CATERPILLAR INC., Peoria, IL (US)

(72) Inventors: Ronald J. Maier, Peoria, IL (US); Joshua Nuechterlein, Washington, IL (US); David McKeever, Hanna City, IL (US); Micah Stutzman, Pittsboro, NC (US); Scott Hicks, Sumter, SC (US); Marlyn Elstrom, Bishopville, SC (US)

(73) Assignee: Caterpillar Inc., Peoria, IL (US)

(21) Appl. No.: 13/717,877

(22) Filed: Dec. 18, 2012

(51) Int. Cl. B62D 55/084; F16C 33/66

(52) U.S. Cl. CPC B62D 55/0842; F16C 33/6696
USPC 180/9.5; 384/91; 403/119

(57) ABSTRACT

An equalizer bar end joint may include a pin defining a longitudinal axis; and a bearing configured to support the pin. The bearing may include an inner race including a bore configured to cooperate with the pin and a semispherical outer surface. The bearing may also include an outer race including a semispherical inner surface, wherein the semispherical inner surface of the outer race is configured to cooperate with the semispherical outer surface of the inner race. A solid lubricant may be disposed about a surface of the bore, and a first seal may be positioned within a first groove disposed about the bore at a first end and a second seal may be positioned within a second groove disposed about the bore at a second end.

### TECHNICAL FIELD

The disclosure generally relates to an equalizer bar assembly and in particular, to an equalizer bar end joint assembly for connecting a track roller frame to a track-type machine.

### BACKGROUND

Track type machines commonly use a pair of tracks connected by an equalizer bar between to allow a degree of flexibility in movement of the tracks relative to the main frame. The equalizer bar is mounted to the main frame and each end of the equalizer bar is connected to one of the left hand or right hand side track roller frame. The connection between the equalizer bar and the track roller frame must allow some degree of movement between the equalizer bar and the track roller frame while being able to sustain severe loading. A spherical bearing may be provided at each end of the equalizer bar to provide three degrees of movement: axially, rotationally about the axis, and rotationally in the plane of the axis (or cocking).

The spherical bearing requires lubrication to allow for smooth movement and to mitigate binding. Lubrication may be accomplished by providing liquid or semi-solid lubricants, such as oil and/or grease, to the bearing surfaces. However, such methods of bearing lubrication require considerable maintenance and disposal of used lubricant. Attempting to address the issue, U.S. Patent Application Publication 2007/0009757 discloses a sintered sliding material layer including copper and/or a copper-molybdenum alloy and a solid lubricant such as polytetrafluoroethylene (PTFE), commonly known as “Teflon,” which is incorporated into a bearing for an equalizer bar suspension. However, because the solid lubricant is interspersed within the grains of the metal alloy structure, abrasion between the metal components is likely to result.

The disclosed embodiments are directed to overcoming one or more of the problems set forth above and other problems in the art.

### SUMMARY

One aspect of the present disclosure is directed to an equalizer bar end joint. The equalizer bar end joint may include a pin defining a longitudinal axis; and a bearing configured to support the pin. The bearing may include an inner race including a bore configured to cooperate with the pin and a semispherical outer surface. The bearing may also include an outer race including a semispherical inner surface, wherein the semispherical inner surface of the outer race is configured to cooperate with the semispherical outer surface of the inner race. A solid lubricant may be disposed about a surface of the bore, and a first seal may be positioned within a first groove disposed about the bore at a first end and a second seal may be positioned within a second groove disposed about the bore at a second end.

Another aspect of the present disclosure is directed to a bearing for an equalizer bar end joint. The bearing may include an inner race including a bore configured to cooperate with the pin and a semispherical outer surface and an outer race including a semispherical inner surface, wherein the semispherical inner surface of the outer race is configured to cooperate with the semispherical outer surface of the inner race. The bearing may also include a solid lubricant disposed about a surface of the bore. The bearing may also include a first seal positioned within a first groove disposed about the bore at a first end and a second seal positioned within a second groove disposed about the bore at a second end.

Another aspect of the present disclosure is directed to a machine having an equalizer bar with one or more end joints. The machine may include a first track frame and a second track frame spaced apart from the first track frame and an equalizer bar positioned between and connected to the first track frame and the second track frame. The equalizer bar may include a first passage through the equalizer bar, the first passage defining a first longitudinal axis. A first pin joint assembly may be disposed within the first passage. The first pin joint assembly may include a first pin positioned along the first longitudinal axis, and a first bearing supporting the first pin within the first passage. The first bearing may include a first inner race and a first outer race. The first inner race may include a first convex outer surface, a first bore configured to receive the first pin, a solid lubricant disposed on a surface of the bore adjacent the pin, and a pair of first seals positioned at either end of the bore. The first outer race may include a first concave inner surface configured to cooperate with the first convex outer surface, a solid lubricant disposed on the first concave inner surface, and a pair of second seals positioned at either end of the first outer race. The first pin joint assembly may be configured to allow the first pin three degrees of motion about the first longitudinal axis.

### BRIEF DESCRIPTION OF THE DRAWINGS

FIG. 1 is a representation of an exemplary machine having a bearing assembly in accordance with an embodiment of the present disclosure.

FIG. 2 is a representation of an exemplary track roller frame of the machine shown in FIG. 1.

FIG. 3 is a cross section taken along line 3-3 of FIG. 2 showing a portion of the track roller frame and the equalizer bar comprising a pin joint assembly in accordance with the present disclosure.

FIG. 4 is a detailed view of a bearing included in the cross sectional view of the pin joint assembly shown in FIG. 3.

### DETAILED DESCRIPTION

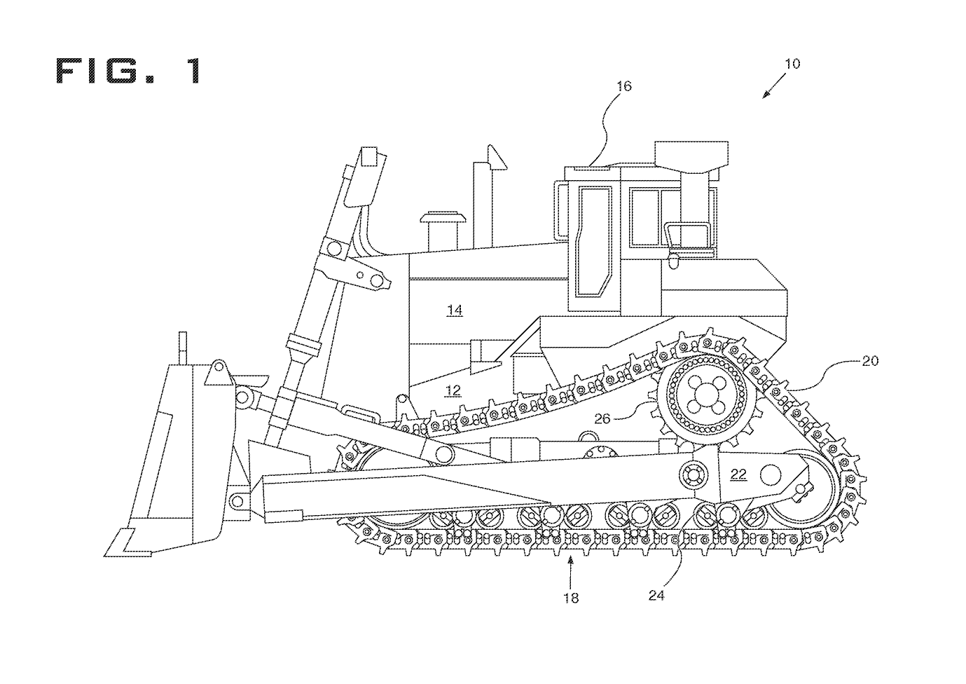

An exemplary embodiment of a machine 10 is shown in FIG. 1. The machine 10 may be a mobile machine that performs some type of operation associated with an industry such as mining, construction, farming, transportation, or any other industry known in the art. For example, the machine 10 may be a track-type tractor, as depicted in FIG. 1, having a frame 12 arranged for supporting a power source 14 configured to provide power to the various systems of machine 10. Machine 10 may also include an operator station 16 and an undercarriage 18 having ground engaging members 20. In the exemplary embodiment shown in FIG. 1, the ground engaging members 20 may be a ground engaging track positioned on the left and right (not shown) sides of machine 10.

The undercarriage 18 may further include a track frame 22, upon which the ground engaging track 20 may be mounted. Track frame 22 may also include a number of rollers 24 configured to support and guide the ground engaging track 20. The undercarriage may also include a drive member 26 coupled to the power source 14 by way of a drive train (not shown) and configured to engage and drive ground engaging track 20.

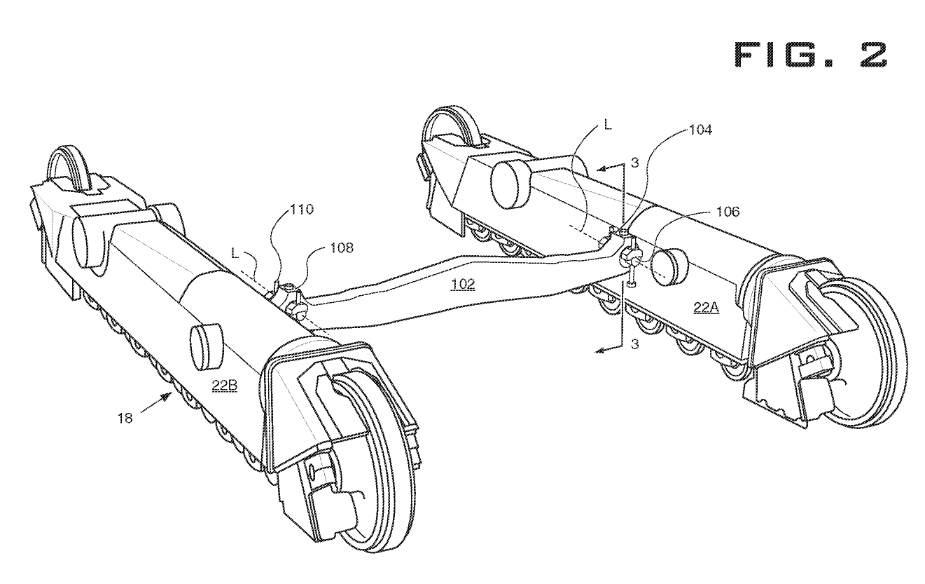

Referring now to FIG. 2, the undercarriage 18 may be configured to include a first track frame 22A and a second track frame, which may be disposed on the left and right sides of machine 10, respectively. An equalizer bar 102 may be disposed between first and second track frames 22A, 22B. The equalizer bar 102 may include a first end 104 connected to first track frame 22A by a first end joint 106 and a second end 108 coupled to second tack frame 22B by a second end joint 110.

The first end joint 106 and the second end joint 110 may be configured to accommodate movement while maintaining alignment of the first track frame 22A and the second track frame 22B relative to each other as the machine 10 travels over uneven ground. First track frame 22A and second track frame 22B may each be connected to equalizer bar 102 in a similar manner. Therefore, only the first end joint 106 will be discussed in further detail, however, it should be understood that the same principles and teachings of the disclosure apply equally to the second end joint 110 connecting the second track frame 22B to the second end 108 of equalizer bar 102.

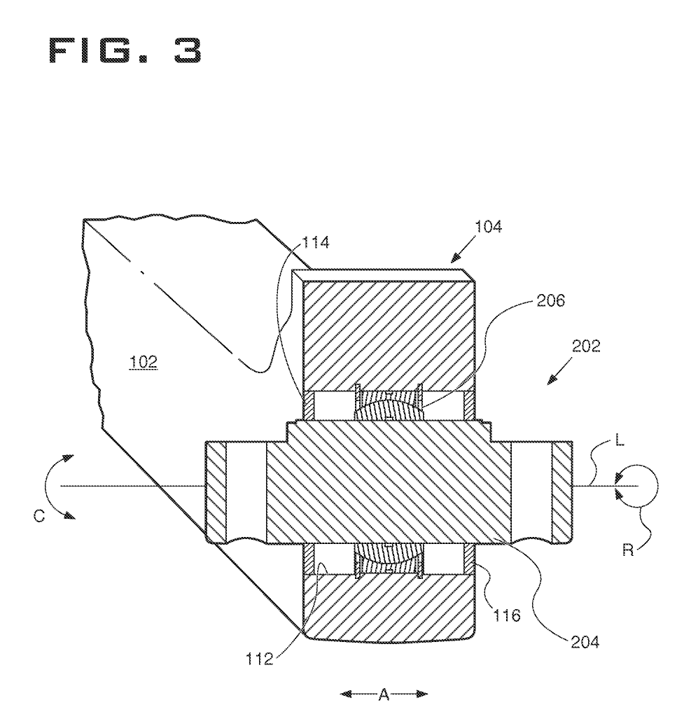

Referring to FIG. 3, the first end 104 of equalizer bar 102 may include a passage 112 configured to receive a pin joint assembly 202. The pin joint assembly 202 may include a pin 204, and a bearing 206 disposed within the passage 112 and configured to receive the pin 204. The bearing 206 may be press fit within the passage 112, or may be held in place by any suitable means known in the art, such as retaining rings or snap rings positioned on either side of the bearing. Further, the equalizer bar 102 may include a first joint seal 114 and a second joint seal 116 disposed about pin 204 and within passage 112. The joint seals 114, 116 being configured to inhibit infiltration of dirt, dust, debris, and other contaminant material into the into passage 112, thereby keeping such material away from bearing 206. Joint seals 114, 116 may be constructed from rubber, such as natural or synthetic rubber, nitrile butadiene rubber, silicone rubber, EPDM rubber, or any suitable material. Also, joint seals may have a composite construction including a nylon inner band configured to be disposed about the pin 204, a steel outer band configured for cooperation with passage 112 and a flexible portion between the inner and outer bands (not shown).

The pin 204 may extend through the bearing 206 along a longitudinal axis L and may project from at least one side of the equalizer bar 102. In some embodiments, the pin 204 may extend along the longitudinal axis L and project from two sides of the equalizer bar 102. The pin 204 is further adapted to move relative to the equalizer bar 102 such that the pin 204 has a plurality of rotational degrees of freedom along the longitudinal axis L.

The pin 204 and the bearing 206 may define a connection arrangement with the equalizer bar 102 that permits the pin 204 to rotate in the direction R about the longitudinal axis L, to pivot (or cock) in the direction C along a vertical plane intersecting the longitudinal axis L, and to translate axially in the direction A along the longitudinal axis L, as shown in FIG. 3. In some embodiments, the pin 204 movement may be described using three degrees of freedom commonly known as pitch, yaw, and roll.

In an exemplary embodiment of the present disclosure, the pin 204 may be nickel coated to provide improved surface finish and corrosion resistance over a chrome coated pin. For example, a nickel coating may be applied to pin 204 so that the surface finish has a roughness value of Ra=0.4 microns or less.

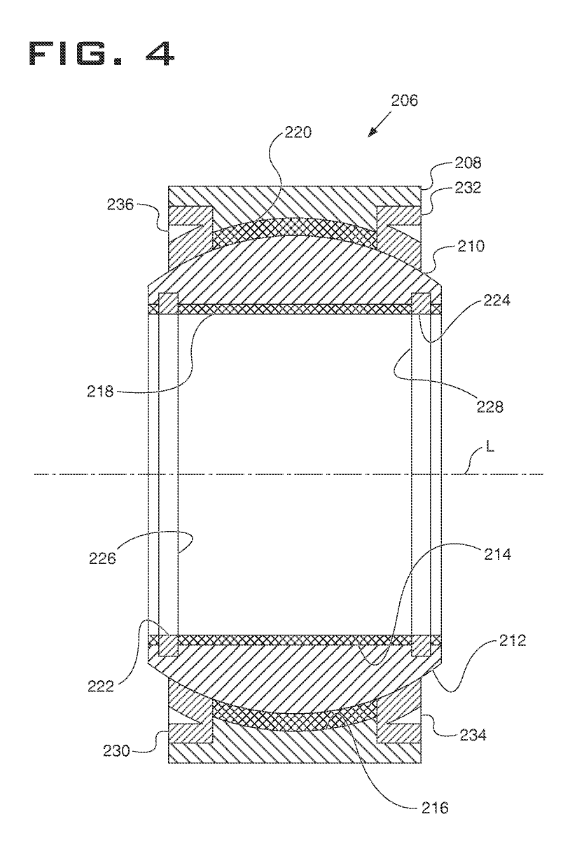

In an embodiment of the present disclosure, the bearing 206 may include, as shown, for example, in FIG. 4, an outer member or race 208 and an inner member or race 210. The inner race 210 may include a convex semispherical outer profile 212 and a generally cylindrical bore 214 configured to receive pin 204 (not shown in FIG. 4). Outer race 208 may include a concave semispherical inner profile 216 configured to cooperate with the semispherical outer profile 212 of inner race 210.

The inner race 210 may be configured to move and rotate within the confines of the outer race 208 during normal operation. The bore 214 may be configured to receive pin 204 so that pin 204 is oriented with its longitudinal axis L extending through the bore 214 as shown.

The bearing 206 may further include a first liner 218 including a polytetrafluoroethylene (PTFE) layer disposed about an internal surface of bore 214, and a second liner 220 including a PTFE layer disposed about a surface of the concave semispherical inner profile 216 of the outer race 208. First liner 218 and second liner 220 may be arranged as a single layer of PTFE bonded to their respective bearing surfaces, a PTFE fabric, a multi-layered laminated material, or any other acceptable arrangement and/or combination thereof.

The bearing 206 may also include a set of seals configured to inhibit infiltration of dirt, dust, debris, and other contaminants into the bearing. In the exemplary embodiment shown in FIG. 4, the bearing may include pin seals 222, 224 disposed within grooves 226, 228 positioned at either end of the bearing 206 about the inner surface of bore 214 and laterally of the first liner 218. The exemplary bearing shown may include bearing seals 230, 232 disposed within seal pockets 234, 236 positioned at either end of the outer race 208 and laterally of the second liner 220.

Pin seals 222, 224 and bearing seals 230, 232 may be constructed from rubber, such as natural or synthetic rubber, nitrile butadiene rubber, silicone rubber, EPDM rubber, or any suitable material.

### INDUSTRIAL APPLICABILITY

Machines having a tracked undercarriage having a pair of track roller frames mounted to the frame of the machine and connected to an equalizer bar at each end may include but are not limited to track type tractors, hydraulic excavators, tracked loaders, multi-terrain loaders, as well as other types of earth moving and industrial equipment. As a machine travels across terrain with varying contours, the pin joint assemblies on the equalizer bar allow the undercarriage some flexibility while the ground engaging members maintain contact with the ground.

The bearings in pin joint assemblies located on either end of the equalizer bar require lubrication to allow relative movement between the ground engaging members. An oil-based or grease-based lubricant requires regular maintenance, which results in higher costs and reduced machine availability. In the exemplary embodiment of the present disclosure, PTFE liners are provided as a solid lubricant, reducing the need for regular maintenance. Additionally, the equalizer bar end joint of the present disclosure eliminates the need to provide lubrication conduits or ports within either the equalizer bar or the bearing. Further, seals are provided to inhibit infiltration of dirt and other debris into the bearing, which could degrade the bearing surfaces and the PTFE liners.

Although embodiments of this disclosure have been described herein, improvements and modifications may be incorporated without departing from the scope of the following claims.

What is claimed is:

1. An equalizer bar end joint comprising:
a pin defining a longitudinal axis; and
a bearing configured to support the pin, the bearing comprising
an inner race including a bore configured to cooperate with the pin and a semispherical outer surface,
an outer race including a semispherical inner surface, wherein the semispherical inner surface of the outer race is configured to cooperate with the semispherical outer surface of the inner race,
a solid lubricant disposed about a surface of the bore, and
a first bearing seal positioned within a first seal pocket located on the outer race at a first end and a second bearing seal positioned within a second seal pocket located on the outer race at a second end.

2. The equalizer bar end joint of claim 1 wherein the bearing further comprises:
a solid lubricant disposed about the semispherical inner surface;
a first pin seal positioned within a first groove disposed about the bore at a first end; and
a second pin seal positioned within a second groove disposed about the bore at a second end.

3. The equalizer bar end joint of claim 2 wherein the semispherical outer surface of the inner race is convex and the semispherical inner surface of the outer race is concave.

4. The equalizer bar end joint of claim 2 wherein the solid lubricant comprises polytetrafluoroethylene.

5. The equalizer bar end joint of claim 4 wherein the solid lubricant comprises a polytetrafluoroethylene fabric.

6. The equalizer bar end joint of claim 4 wherein the solid lubricant comprises a polytetrafluoroethylene laminate.

7. The equalizer bar end joint of claim 2 wherein the bearing is positioned within a passage through one end of the equalizer bar.

8. The equalizer bar end joint of claim 7 wherein the bearing is configured to allow the pin three degrees of movement.

9. A bearing for an equalizer bar end joint, the bearing comprising:
an inner race including a bore configured to cooperate with a pin and a semispherical outer surface, an outer race including a semispherical inner surface, wherein the semispherical inner surface of the outer race is configured to cooperate with the semispherical outer surface of the inner race;
a solid lubricant disposed about a surface of the bore; and
a first bearing seal positioned within a first seal pocket located on the outer race at a first end and a second bearing seal positioned within a second seal pocket located on the outer race at a second end.

10. The bearing of claim 9 further comprising:
a solid lubricant disposed about the semispherical inner surface;
a first pin seal positioned within a first groove disposed about the bore at a first end; and
a second pin seal positioned within a second groove disposed about the bore at a second end.

11. The bearing of claim 9 wherein the semispherical outer surface of the inner race is convex and the semispherical inner surface of the outer race is concave.

12. The bearing of claim 10 wherein the solid lubricant comprises polytetrafluoroethylene.

13. The bearing of claim 12 wherein the solid lubricant comprises a polytetrafluoroethylene fabric.

14. The bearing of claim 12 wherein the solid lubricant comprises a polytetrafluoroethylene laminate.

15. The bearing of claim 9 further comprising a first bearing seal positioned within a first seal pocket located on the outer race at a first end and a second bearing seal positioned within a second seal pocket located on the outer race at a second end.

16. The bearing of claim 10, wherein the bore is configured to receive and support the pin such that the pin is allowed three degrees of movement.

17. A machine comprising:
a first track frame and a second track frame spaced apart from the first track frame;
an equalizer bar positioned between and connected to the first track frame and the second track frame, the equalizer bar comprising
a first passage through the equalizer bar, the first passage defining a first longitudinal axis;
a first pin joint assembly disposed within the first passage, the first pin joint assembly comprising
a first pin positioned along the first longitudinal axis, and
a first bearing supporting the first pin within the first passage, the first bearing including a first inner race and a first outer race,
the first inner race including a first convex outer surface , a first bore configured to receive the first pin and a solid lubricant disposed on a surface of the first bore adjacent the first pin,
the first outer race including a first concave inner surface configured to cooperate with the first convex outer surface and a solid lubricant disposed on the first concave inner surface; and
a first pair of joint seals disposed about the first pin within the first passage,
wherein the first pin joint assembly is configured to allow the first pin three degrees of movement about the first longitudinal axis.

18. The machine of claim 17 wherein the equalizer bar further comprises:
a second passage through the equalizer bar, the second passage defining a second longitudinal axis;
a second pin joint assembly disposed within the second passage, the second pin joint assembly comprising
a second pin positioned along the second longitudinal axis, and
a second bearing supporting the second pin within the second passage, the second bearing including a second inner race and a second outer race,
the second inner race including a second convex outer surface , a second bore configured to receive the second pin and a solid lubricant disposed on a surface of the second bore adjacent the second pin
the second outer race including a second concave inner surface configured to cooperate with the second convex outer surface, a solid lubricant disposed on the second concave inner surface; and
a second pair of joint seals disposed about the second pin within the second passage,
wherein the second pin joint assembly is configured to allow the second pin three degrees of movement about the first longitudinal axis.

19. The machine of claim 18 wherein the solid lubricant comprises polytetrafluoroethylene.

20. The machine of claim 19 wherein the solid lubricant is a polytetrafluoroethylene fabric.
